(19) United States
(12) Patent Application Publication
(10) Pub. No.: US 2025/0010272 A1
(43) Pub. Date: Jan. 9, 2025

(54) METHOD OF PRODUCTION OF METAL-CONTAINING SPHERICALLY POROUS CARBON PARTICLES

(71) Applicant: TECHNISCHE UNIVERSITÄT BERLIN, Berlin (DE)

(72) Inventors: Denis Bernsmeier, Berlin (DE); Ralph Krähnert, Berlin (DE); Benjamin Paul, Berlin (DE)

(21) Appl. No.: 18/705,744

(22) PCT Filed: Oct. 26, 2022
(86) PCT No.: PCT/EP2022/079928

§ 371 Date: Apr. 29, 2024

(30) Foreign Application Priority Data
Oct. 29, 2021 (EP) 21205514.9

(51) Int. Cl. B01J 21/18; B01J 23/42; B01J 35/23; B01J 35/45; B01J 35/51; B01J 37/00; B01J 37/02; B01J 37/08

(52) U.S. Cl. CPC B01J 21/18; B01J 23/42; B01J 35/23; B01J 35/45; B01J 35/51; B01J 37/0018; B01J 37/0211; B01J 37/084; B01J 37/086

(57) ABSTRACT

The present disclosure relates to a method for the production of metal-containing spherically porous carbon particles. For this purpose, a carbon precursor is preferably polymerized with a structure-forming template in a solvent to form a polymer solution in a first step, the metal compound is added to the polymer solution in a second step and finally the metal-containing spherically porous carbon particles are formed in a third step by means of an aerosol spraying method. In addition, the present disclosure relates to a method for producing an ink and a use of the metal-containing spherically porous carbon particles as a catalyst.

### CROSS REFERENCE TO RELATED APPLICATIONS

The present application is a national stage application claims the benefit of priority under 35 U.S.C. § 371 from PCT/EP2022/079928, filed on Oct. 26, 2022, which claims the benefit of priority from EP21205514.9, filed on Oct. 29, 2021, all of which is incorporated herein by reference in its entirety for all purposes.

### TECHNICAL FIELD

The present disclosure relates to a method for the production of metal-containing spherically porous carbon particles. For this purpose, a carbon precursor is preferably polymerized with a structure-forming template in a solvent to form a polymer solution in a first step, the metal compound is added to the polymer solution in a second step and finally the metal-containing spherically porous carbon particles are formed in a third step by means of an aerosol spraying method.

In addition, the present disclosure relates to a method for producing an ink and a use of the metal-containing spherically porous carbon particles as a catalyst.

### BACKGROUND

Metal nanoparticles on carbon are frequently used catalysts in heterogeneous catalysis and electrocatalysis. Classically, these catalysts are synthesized by impregnating the carbon carrier with ionic precursor species and subsequent reduction. The carbon carrier can also be subsequently impregnated with preformed colloidal nanoparticles. However, it is then difficult to distribute these particles homogeneously in the pore system of the carrier. The targeted adjustment of the pore morphology as well as the control of the particle size and particle composition pose problems in this type of synthesis. Carbon-based synthesis often involves the use of binders, which can adversely block the pores or nanoparticles. The binder is used, for example, in the preparation of the catalyst on a substrate, e.g. in ink coating.

Various approaches are known in the prior art for attaching nanoparticles, in particular metal nanoparticles, to carbon.

US 2013/0183511 A1 discloses a conductive mesoporous carbon composite with conductive carbon nanoparticles contained in a mesoporous carbon matrix. The conductive mesoporous carbon composite has mesopores located within the mesoporous carbon matrix and/or extending through the surfaces of said conductive carbon nanoparticles when the conductive carbon nanoparticles are fused together. In the method used for this purpose, a precursor is treated in a hardening step followed by carbonization. The precursor comprises a template consisting of a block copolymer, a phenolic component, an aldehyde component and an acid catalyst. In particular, metallic nanoparticles can be doped. However, the nanoparticles are not optimally distributed on the mesoporous carbon. Instead, the nanoparticles essentially lie on the surface of the carrier.

EP 3363538 A1 discloses a method for producing a mesoporous carbon composite comprising a mesoporous carbon phase and preformed metal nanoparticles located within the mesoporous carbon phase. First, a solution comprising a carbon precursor is provided, wherein the solution also contains a template. After polymerization to obtain the carbon precursor dispersed in the first solvent, the polymer is separated from the first solvent and the metal nanoparticles are added to the polymer or both are dispersed in a second solvent to obtain a mixture. The mixture is then subjected to heat treatment and then carbonization.

WO 2018/150047 A1 and Bemsmeier et al. (2016) (“Highly active binder-free catalytic coatings for heterogeneous catalysis and electrocatalysis: Pd on mesoporous carbon and its application in butadiene hydrogenation and hydrogen evolution.” ACS Catalysis 6.12 (2016): 8255-8263) disclose a method for the production of mesoporous carbon which includes metal nanoparticles in their mesopores. A mesoporous film is formed on a suitable substrate using a coating method. This makes it possible to achieve a good distribution of the nanoparticles in the mesoporous film. The disadvantage of this, however, is that the pore system formed in the film is not very flexible in the applications.

In the prior art, methods are also known that use an aerosol spraying method to synthesize mesoporous carbon spheres.

For example, US 2009/0304570 A1 discloses a synthesis approach using a spray method for mesoporous carbon. The mesoporous carbon does not contain any metal nanoparticles. Metals are only named as possible hard templates, but these are removed in a subsequent synthesis step. The carbon produced in this way is therefore not well suited for electrocatalytic reactions.

US 2011/0082024 A1 discloses a method for the production of porous carbon in which noble metal salts are added to a carbon precursor solution. For this purpose, only hard templates in the form of silicon spheres are described.

CN 103663410 B discloses the use of an ultrasonic evaporator for the production of mesoporous carbon particles. Highly viscous tar pitch is used as a precursor, which is melted before being fed into the ultrasonic evaporator. Transfer to the ultrasonic evaporator takes place via an extruder. The carbon particles do not contain any metals.

With regard to the use as a catalyst, the use of metals, in particular precious metals, in porous carriers, such as carbon, is an approach that is considered promising in the prior art. It is also known to provide or use such catalysts as catalyst inks. In Xu et al. (2010) (“Investigation of a catalyst ink dispersion using both ultra-small-angle X-ray scattering and cryogenic TEM.” Langmuir 26.24 (2010): 19199-19208), methods for investigating a dispersion of Nafion ionomer particles and a Pt/C (platinum/carbon) catalyst as a catalyst ink are discussed, which is relevant for studies on the quality of the catalyst, for example. USAX (ultra-small angle X-ray scattering) and cryogenic electron microscopy (cryogenic TEM) methods are used. The carbon used for the catalyst ink can be provided in the form of spherical particles.

An efficient, cost-effective, and easily reproducible method for the production of metal-containing spherically porous carbon particles is not known from the prior art.

### SUMMARY

In one embodiment, a method for producing metal-containing spherically porous carbon particles includes the following steps: (a) polymerization of a carbon precursor with a structure-forming template by addition to a first solvent to form a polymer solution containing template-carbon polymer complexes; (b) addition of a metal compound to the polymer solution from the previous step; and (c) vaporization and thermal treatment of the polymer solution containing the metal compound from the previous step in an aerosol spraying method to form metal-containing spherical carbon particles, wherein during the thermal treatment the template is decomposed and pores are formed within the carbon particles.

In another embodiment, metal-containing spherical carbon particles are produced by a manufacturing method, including: (a) polymerization of a carbon precursor with a structure-forming template by addition to a first solvent to form a polymer solution containing template-carbon polymer complexes; (b) addition of a metal compound to the polymer solution from the previous step; and (c) vaporization and thermal treatment of the polymer solution containing the metal compound from the previous step in an aerosol spraying method to form metal-containing spherical carbon particles, wherein during the thermal treatment the template is decomposed and pores are formed within the carbon particles.

In another embodiment, a method of preparing and using an ink for a coating includes steps of production of metal-containing spherically porous carbon particles by: (a) polymerization of a carbon precursor with a structure-forming template by addition to a first solvent to form a polymer solution containing template-carbon polymer complexes; (b) addition of a metal compound to the polymer solution from the previous step; and (c) vaporization and thermal treatment of the polymer solution containing the metal compound from the previous step in an aerosol spraying method to form metal-containing spherical carbon particles, wherein during the thermal treatment the template is decomposed and pores are formed within the carbon particles. The method also includes processing the metal-containing spherically porous carbon particles produced in steps (a), (b), and (c) into the ink.

### BRIEF DESCRIPTION OF DRAWINGS

In the following, the present disclosure will be explained in more detail with the aid of figures, without being limited to these.

FIG. 1 is a schematic representation of a preferred method for the production of metal-containing spherically porous carbon particles.

FIGS. 2a and 2b are a SEM image and size distribution of platinum-containing carbon particles.

FIGS. 3a and 3b are SEM images of carbon particles containing platinum.

FIGS. 4a and 4b are an isotherm from a physisorption measurement and a pore size distribution.

FIGS. 5a, 5b, and 5c are a TEM image, a size distribution, and a TEM image in high resolution of platinum-containing carbon particles.

FIG. 6 is an X-ray diffractogram of carbon particles containing platinum.

### DETAILED DESCRIPTION

The task of the present disclosure was to eliminate the disadvantages of the prior art and to offer a method with which metal-containing spherically porous carbon particles can be produced.

The problem according to the present disclosure is solved by the features of the independent claims. Advantageous embodiments of the present disclosure are described in the dependent claims.

In a preferred embodiment, the present disclosure relates to methods for the production of metal-containing spherically porous carbon particles comprising the following steps: (a) polymerization of a carbon precursor with a structure-forming template by addition to a first solvent to form a polymer solution containing template-carbon polymer complexes, (b) addition of a metal compound to the polymer solution from the previous step, (c) vaporization and thermal treatment of the polymer solution containing the metal compound from the previous step in an aerosol spraying method to form metal-containing spherical carbon particles, wherein during the thermal treatment the template is decomposed and pores are formed within the carbon particles.

The method according to the present disclosure is a departure from the prior art, since a polymer solution containing a metal compound (in particular metal nanoparticles or a metal salt) is combined with an aerosol spraying method in order to produce metal-containing, spherically porous carbon particles. In this respect, the prior art contained no indications that the use of an aerosol spraying method enables a particularly homogeneous distribution of metal nanoparticles in mesoporous carbon spheres.

Ensuring an advantageous nanostructuring of the carbon spheres in the presence of a metal compound, on the other hand, is a surprising discovery by the inventors. In its entirety, the method has proven to be extremely beneficial. The spherical metal-containing carbon particles produced can be specifically adjusted both in terms of the shape of their pores, in particular their pore size, and in terms of their proportion of metal nanoparticles. The aerosol spraying method also distributes the metal nanoparticles homogeneously on and within the spherical, porous carbon particles. The porous structure of the carbon is obtained by the decomposition of the template during the thermal treatment in the aerosol method itself, whereby the pores are introduced in a repeatable and coordinated manner together with the metal nanoparticles.

The production of carbon particles in spherical form is also advantageous, as spherical carbon particles can be handled more flexibly and thus open up a wider range of applications. This means that the metal-containing, spherical carbon particles can be stored easily and can be used to produce a dispersion or ink if required. Using a coating method, the metal-containing, spherical carbon particles can be applied flexibly and without complications as a catalytic layer for various applications. As a further advantage, a large number of spherical carbon particles together have an increased surface area compared to a carbon phase, which is present as a layer. This advantageously results in a larger reaction surface and reactivity, which is particularly advantageous for applications for electrocatalytic reactions.

The combination of the method steps was not obvious to a person skilled in the art. For example, the person skilled in the art could not expect the carbon to retain a nanostructure when thermally treated during the aerosol spraying method. In particular, this was not to be expected in the presence of metallic nanoparticles or metal salts.

The inventors were confronted with various problems in the development of the preferred method and had to solve them by applying a high degree of inventive thought. The combination of the present method steps leads to a surprising synergy effect, which results in the advantageous properties and the associated overall success of the present disclosure, whereby the individual features interact with each other. An important advantage of the method according to the present disclosure is the extremely fast, reproducible and economical synthesis procedure.

It has been shown to be advantageous that the metal nanoparticles can be distributed particularly well to the carbon particles by combining the aerosol spraying method with the thermal treatment of the metal-containing template-carbon polymer complexes. In particular, the timing of the addition of the metal species differs from the prior art, since according to the present disclosure they are added before the aerosol spraying method and after the formation of the template-carbon polymer complexes, i.e. in particular before so-called carbonization. In the prior art (see above), it is instead known that the metal species is added in an additional step after carbonization. Here, carbonization preferably refers to the process of converting the carbon precursor into other forms, for example into a film or spherical particles, for example by thermal treatment.

For the purposes of the present disclosure, the term “spherical” preferably refers to an essentially spherical configuration of the carbon particles produced. The term “sphericity” can also be used here to characterize the essentially spherical shape of the carbon particles. Spherical carbon particles preferably have a sphericity of 0.7, 0.8, 0.9 or more. The sphericity is to be understood as a parameter that characterizes the proportion to which a spherical shape is approximated. The sphericity of a body preferably corresponds to the ratio of the surface area of a sphere of the same volume to the surface area of the body. A sphere therefore has a sphericity of 1, while a cube, for example, has a sphericity of approx. 0.8.

For the purposes of the present disclosure, the term porous preferably refers to the smallest recesses in the carbon particles produced, so that they are perforated. The term “pored” or similar expressions can also be used synonymously. Typical pore sizes are in the nanometer range.

Polymerization in the sense of the present disclosure is preferably a collective term for chemical reactions in which monomers (short-chain molecules) react to form polymers (long-chain molecules). Catalysts can also be used in this process.

For the purposes of the present disclosure, a precursor preferably refers to a starting product of a chemical reaction, in particular the polymerization in method step a). The term “carbon precursor” preferably means a precursor comprising carbon and/or a compound comprising carbon which is polymerizable.

In the context of the present disclosure, a structure-forming template preferably refers to a chemical compound and/or a mixture which determines the structure of the polymer phase formed by the polymerizable carbon precursor. In this sense, the structure-forming template enables the formation of a structured polymer phase in which structures generated by the structure-forming template, such as micelles and/or lamellar structures, are enclosed in the polymer formed from the polymerizable carbon precursor. Subsequent removal of the template structures (e.g. micelles) leaves intermediate spaces as pores of a porous carbon phase formed in this way.

In method step a) of the method according to the present disclosure, the carbon precursor with a structure-forming template is added to a first solvent so that a polymer solution is formed.

The template is preferably used as a placeholder for a desired pore structure. During the method according to the present disclosure, the template is preferably enclosed by the surrounding material, the carbon precursor, and leaves a porous structure after its removal. Preferably, the template is removed during the thermal treatment in an aerosol spraying method. Depending on the size of the template, pore structures with pore sizes ranging from a few micrometers to a few nanometers are created. Materials with an ordered pore structure and a monodomal pore size distribution can therefore preferably be synthesized using so-called templating methods. In this synthesis approach, templates serve as placeholders for the desired pore shape.

Preferably, the carbon precursor can be present in a carbon precursor solution in method step a), so that a dispersion is preferably formed by the addition of the template in combination with a first solvent.

A metal and/or a metal compound is then added to the polymer solution formed in method step a) in method step b). In particular, the metal species are added before carbonization, i.e. before thermal treatment during the aerosol spraying method. The addition of the metal species results in a dispersion comprising template-carbon polymer complexes and the metal compound. The metal compound can preferably be added in the form of colloidal metal nanoparticles or as a metal salt. Further treatment of the dispersion is then carried out in an aerosol spraying method in accordance with method step c).

For the purposes of the present disclosure, the term “metal species” and “metal compound” can be used synonymously.

In method step c), the polymer solution with the added metal and/or metal compound is vaporized in an aerosol spraying method and thermally treated. Aerosols are formed by vaporization, wherein vaporization is preferably carried out using an ultrasonic evaporator (also known as an ultrasonic vaporizer or ultrasonic atomizer). For this purpose, an inert carrier gas is preferably fed to the ultrasonic vaporizer, which transfers the aerosols into a heated zone. This can preferably be done via a quartz tube. Thermal treatment takes place in the heated clay zone. During the thermal treatment, the metal-containing spherical carbon particles are formed and the template is decomposed. Decomposition takes place by evaporation of the template, leaving pores in the spherical carbon particles.

In the sense of the present disclosure, vaporization preferably refers to a separation of the first solution with the template-carbon polymer complexes into fine droplets as aerosols. The resulting aerosols are also known as spray. These can either comprise drops or droplets which all have the same or similar diameters—also known as a monodisperse spray—or contain drops of different sizes.

For the purposes of the present disclosure, thermal treatment refers to the supply of heat to higher energies.

The metal-containing spherically porous carbon particles are formed during the thermal treatment. In particular, the template is decomposed and leaves pores in the carbon particles. The metal species is distributed within the porous spherical carbon particles. The metal-containing spherical carbon particles formed preferably have a diameter of 50 nm (nanometers) to 5 μm (micrometers), preferably from 100 nm to 2 μm, particularly preferably from 200 nm to 1500 nm.

In accordance with the present disclosure, the aerosol spraying method preferably comprises vaporizing, thermally treating and/or depositing the metal-containing spherical carbon particles on a collector, wherein the metal-containing spherical carbon particles are preferably conveyed to the collector by means of an inert gas. Vaporization in particular is a key feature of the aerosol spraying method in order to form aerosols. Each aerosol can be used for the synthesis, so that a particularly pronounced homogeneity of the carbon particles can be achieved. The aerosol spraying method therefore differs significantly from methods such as dip coating, spray pyrolysis, etc.

Terms such as “essentially,” “approximately,” “about,” “approx.” etc. preferably describe a tolerance range of less than ±40%, preferably less ±20%, particularly preferably less ±10%, even more preferably less than ±5% and in particular less than ±1% and always comprise the exact value. “Similar” and/or “approx.” preferably describes sizes that are “approximately the same.” “Partially” describes preferably at least 5%, particularly preferably at least 10% and especially at least 20%, in some cases at least 40%.

In a further preferred embodiment, the method is characterized in that the carbon precursor comprises at least one phenolic compound and optionally at least one crosslinkable aldehyde compound.

Phenolic compounds or phenols are preferably compounds that consist of an aromatic ring (arene) and one or more hydroxyl groups attached to it.

In a preferred embodiment, the phenolic compound is selected from the group consisting of phenol, pyrocatechol, resorcinol, hydroquinone, phloroglucinol, cresol, halophenol, aminophenol, hydroxybenzoic acid and/or dihydroxybiphenyl.

The above-mentioned phenolic compounds, in particular phenol itself, have proven to be particularly suitable and reliable for polymerization.

For the purposes of the present disclosure, an aldehyde compound preferably refers to a chemical compound comprising an aldehyde. An aldehyde preferably refers to a compound with the functional group —CHO. The functional group refers to the group of atoms in a compound that significantly determines the substance properties and the reaction behavior of the compound. Aldehydes are reactive compounds and can be easily oxidized to carboxylic acid, for example.

For the purposes of the present disclosure, a crosslinkable compound preferably refers to the ability of a molecule or a component of a molecule to link together to form a three-dimensional network.

In a preferred embodiment, the crosslinkable aldehyde compound is selected from a group consisting of formaldehyde, organoaldehyde and/or organodialdehyde represented by the formulae HCHO, R—CHO and OHC—R—CHO, wherein R is a radical which is a straight-chain, branched or cyclic hydrocarbon and can be either saturated or unsaturated and typically contains 1, 2 or 3 carbon atoms and up to 4, 5, 6, 7, 8, 9 or 10 carbon atoms, preferably formaldehyde.

In addition, it is preferred that in the case of an organodialdehyde compound this is glyoxal. Suitable examples of organoaldehydes comprise acetaldehyde, propionaldehyde, butyraldehyde, valeraldehyde, hexanal, crotonaldehyde, acrolein, benzaldehyde and/or furfural.

Examples of suitable organodialdehydes comprise glyoxal, malondialdehyde, succinaldehyde, glutaraldehyde, adipaldehyde, pimelaldehyde, suberaldehyde, sebacaldehyde, cyclopental dialdehyde, terephthaldehyde and/or furfuraldehyde.

In a preferred embodiment, the method is characterized in that the first solvent from method step a) is a protic solvent.

A protic solvent is preferably a solvent that is capable of splitting off hydrogen atoms as protons.

For example, a protic solvent can be a solvent that has one or more of the following properties: It allows hydrogen bonding, i.e. the formation of hydrogen bonds; acidic hydrogen is present, wherein a protic solvent can also be a weak or very weak acid; and it is capable of dissolving salts. Typical examples of suitable first solvents are lower alcohols such as ethanol, methanol etc., water and optionally in the presence of acids. Typically, in embodiments of the present disclosure, polymerization is carried out until polymer clusters are formed which can be separated from the first solvent, for example by decantation. Preferably, these clusters are of such a size and structure that they are also dispersible in a second solvent for further embodiments of the method according to the present disclosure.

In some embodiments, the time period for polymerization of a carbon precursor with a pattern-forming template in a first solvent to form a polymer solution comprising template-carbon polymer complexes is in the range of 1 minute to 60 minutes, preferably 5 minutes to 30 minutes, more preferably 10 minutes to 20 minutes.

Under certain conditions, however, such a polycondensation reaction can also take more than 1 h, more than 2 h, 6 h, 12 h or more than 24 h. For example, if little acid is used, it is preferable to provide more time for the polymerization reaction.

In a further embodiment, the first solvent is selected from a group comprising water, ethanol, methanol, propanol and/or mixtures thereof. An acid or base is also optionally available.

It can therefore be preferred that an acidic or basic component is added to the first solvent, preferably a protic solvent, or is already added within the solvent. It can be added during method step a) during polymerization or even before. Any acid or base capable of accelerating polymerization can be preferred, in particular a reaction between phenol and aldehyde compounds.

The person skilled in the art knows that alkalis refer to aqueous solutions with alkaline/basic properties, so that an alkali comprises a base in aqueous solution and therefore all alkalis are also bases.

Preferably, the acid can be a weak acid, for example a weak organic acid such as acetic acid, propionic acid and/or citric acid, or a weak inorganic acid such as phosphoric acid. The use of a strong acid can also be preferred, such as mineral acid, hydrochloric acid, hydrochloric acid, hydrobromic acid, hydroiodic acid, sulphuric acid and/or trifluoromethanesulphonic acid.

In a further preferred embodiment, the method is characterized in that, after method step a), the template-carbon polymer complexes are separated from the first solvent by means of a separation method.

Due to the separation, the template-carbon polymer complexes and the first solvent are essentially separate from each other. The separated template-carbon polymer complexes are particularly relevant for the further method.

In some embodiments, after the polymer or polymer solution comprising template-carbon polymer complexes has been separated from the first solvent, it can optionally be washed, for example with an aqueous solvent, and then separated from the wash solution. In some embodiments, such washing and separating steps can be repeated once or several times. Advantageously, undesirable compounds and/or substances in particular can be removed by washing, so that a higher purity and/or improved reaction behavior can be achieved. It is also a great advantage that the polymer or polymer solution can be prepared for storage, for example freeze-dried, after washing. This allows the processes to be decoupled in terms of time and location during production according to the method of the present disclosure. A freeze-dried polymer mixture can advantageously be (temporarily) stored for a long time so that subsequent process steps can be continued at any time later.

In a further preferred embodiment, the method is characterized in that the separation method takes place by sedimentation, filtration, centrifugation, separation, extraction, distillation and/or particularly preferably by decantation.

For the purposes of the present disclosure, sedimentation refers to the sinking of the fine insoluble template-carbon polymer complexes to the bottom of a beaker, container and/or test tube.

For the purposes of the present disclosure, pouring through a filter, for example through a sieve or filter paper. The first solvent flows easily through the pores of the filter. The escaping liquid is also referred to as filtrate. The insoluble solids of the template-carbon polymer complex are larger than the pores of the filter. This remains in the filter. This is also known as precipitation. Under reduced pressure, such filtration is much faster, which can also be preferable.

For the purposes of the present disclosure, centrifugation refers to the use of an apparatus which preferably rotates around an axis so quickly that the centrifugal force causes, for example, test tubes on movable side arms to be brought into a horizontal position. Due to the centrifugal force, the first solvent does not run. The centrifugal force presses the template-carbon polymer complexes firmly to the bottom of the test tube. As this takes place at high pressure, the template-carbon polymer complexes still adhere to the bottom after centrifugation.

Separation preferably refers to the use of a separating funnel. For this purpose, the first solvent is mixed closely with the template-carbon polymer complexes to form a heterogeneous mixture known as an emulsion. If the mixture is placed in a separating funnel, separation takes place and two phases are obtained: The lower phase contains the liquid with the highest density, the upper phase is formed by the liquid with the lower density.

Extraction preferably refers to the dissolving out of substances with the aid of another solvent. This method is based on the different solubility of the individual substances. Extraction can also be carried out using a separating funnel.

In accordance with the present disclosure, a distillation first comprises boiling the first solvent with the template-carbon polymer complexes, wherein the resulting vapor, which is composed of the various volatile components of the solution to be separated, is liquefied again in a condenser by cooling and the condensate is then collected.

Decantation preferably describes the pouring off of the first solvent so that the template-carbon polymer complexes remain.

The separation methods described have proven to be particularly simple, reliable and fast, and are inexpensive and practical to implement.

In a further preferred embodiment, the method is characterized in that the structure-forming template is a template for forming micelle or lamellar structures and is an amphiphilic molecule, preferably a surfactant, particularly preferably a surfactant comprising nonionic, cationic, anionic and/or zwitterionic surfactants and/or mixtures thereof.

Examples of non-ionic surfactants are polyethylene glycol alkyl ether, glucoside alkyl ether, polyethylene glycol octyl phenyl ether, polyethylene glycol alkyl phenyl ether, glycerol alkyl ester, polyoxyethylene glycol sorbitan alkyl ester, block copolymers, e.g. of polyethylene glycol and/or polypropylene glycol, such as poloxamers, and/or polyethoxylated tallow amine.

Examples of cationic surfactants are cetrimonium bromide, cetylpyridinium chloride, benzalconium chloride, benzethonium chloride, dimethyl-dioctadecylammonium chloride and/or dioctadecyldimethylammonium bromide.

Examples of suitable anionic surfactants are alkyl sulphates, alkyl sulphonates, alkyl phosphates and alkyl carboxylates. Specific examples of alkyl sulfates are ammonium lauryl sulfate, sodium lauryl sulfate and the related alkyl ether sulfates, such as sodium laureth sulfate and sodium myreth sulfate. Other examples of anionic surfactants are sodium stearate, sodium lauroyl sarcosinate, perfluorononanoate and/or perfluorooctanoate.

Examples of zwitterionic surfactants are phospholipids such as phosphatidylserine, phosphatidylcholine, phosphatidylethanolamine and/or sphingomyelin. Further examples are (3-[(3-cholamidopropyl)dimethylammonio]-1-propanesulfonate) (CHAPS), cocamidopropyl hydroxyl sultaine and/or cocamidopropyl betaine.

The micelles formed by the structure-forming template can preferably assume any shape, e.g. they can be spherical, spheroidal, ellipsoidal or cylindrical. In some embodiments, the structure-forming template can also form structures other than micelles, such as lamellae.

The structure-forming template in the solution from the carbon precursor allows the formation of a structured polymeric phase, wherein the micelles and/or lamellae are included in the polymer formed from the polymerizable carbon precursor. The micelles and/or lamellae preferably act as template structures. As the template structures (e.g. micelles) are subsequently removed, the remaining spaces are the pore spaces within the porous carbon.

Preferred templates are so-called soft templates, i.e. templates that are decomposed during synthesis. For example, hyperbranched polymers, dendrimers and/or high molecular weight polyethylene oxide can be used for this purpose. Preferably, small spheres comprising polymethyl methacrylate (PMMA), so-called PMMA spheres, can also be used as a template, in particular as a soft template.

Soft templates are deformable structure-directing units. These can be micelles or lamellar structures made of amphiphilic polymers (often block copolymers). Typically, the micelles or lamellae are formed above a critical concentration of a polymer dispersed in a solvent. Soft templates also include dendritic or hyperbranched core-shell polymers, wherein the core and shell of the polymers exhibit different hydrophilicities and are therefore also amphiphilic.

The preferred use of a soft template as a template has proven to be particularly advantageous for the context of the present disclosure. In particular, there should be sufficient cross-linking of the carbon precursor with the soft template to ensure the creation of a pore structure. The soft template is decomposed during the thermal treatment of the polymer solution containing the metal compound, so that after decomposition the carbon particles have a pore structure. This means that the pore structure of the carbon particles is obtained directly during a method step in the manufacturing process. In contrast to the use of a hard template, it is therefore advantageously not necessary to carry out further method steps in order to remove the hard template to provide the pore structure, wherein several steps often have to be carried out for this purpose (as for example in US 2011/0082024 A1, where the removal is carried out by means of acid or alkali). As a result, considerable process efficiency can be achieved, particularly through the use of a soft template. In this way, metal-containing spherically porous carbon particles can be produced faster and with savings in chemical and energy-related resources.

Generally speaking, branched polymers preferably denote a polymer when linear chain molecules are linked to a core building block. In this context, we speak of so-called star polymers. If branching centers are statistically introduced into the individual branches of a star polymer, the result is hyperbranched polymers that have no radial symmetry. Finally, dendrimers are obtained when well-defined branching points are incorporated into the individual arms of a star polymer so that a perfectly branched, centrosymmetric architecture is formed.

Preferably, so-called hard templates can also be used as templates. Hard templates are solid structures that have to be removed in an additional synthesis step. Hard templates are rigid structure-directing units. Nanostructured hard templates include metals, oxides, often silicon oxides (e.g. MCM group, SBA group, FDU group, KIT group, MSU group, TUD group, HMM group, FSM group) and carbons (e.g. CMK group). These hard templates can be individual nanoparticles or larger nanostructured structures. For example, nanoparticles comprising silicon can also be used as hard templates. For example, hydrogen fluoride and/or an alkaline solution can be used to remove the hard templating.

In a further preferred embodiment, the method is characterized in that the structure-forming template is an amphiphilic polymer, preferably an amphiphilic block copolymer, particularly preferably a poloxamer.

In a further preferred embodiment, the method is characterized in that AB-block copolymers (polyethylene oxide-block-polystyrene (PEO-PS), polyethylene oxide-block-polymethyl methacrylate (PEO-PMMA), poly-2-venlypyridine-block-polyallyl methacrylate (P2VP-PAMA), polybutadiene-bock-polyethylene oxide (PB-PEO), polyisoprene-bock-polydimethylaminoethylmetacrylate (PI-PDMAEMA), polybutadiene-bock-polydimethylaminoethylmetacrylate (PB-PDMAEMA), polyethylene-block-polyethylene oxide (PE-PEO), polyisobutylene-block-polyethylene oxide (PIB-PEO) and poly(ethylene-co-butylene)-block-poly(ethylene oxide) (PEB-PEO), polystyrene-block-poly(4-vinylpyridine) (PS-P4VP), polyisoprene-block-polyethylene oxide (PI-PEO), polydimethoxyaniline-block-polystyrene (PDMA-PS), polyethylene oxide block poly-n-ethyl acrylate (PEO-PBA), polybutadiene block poly(2-vinylpyridine (PB-P2VP)), polyethylene oxide block polylactide (PEO-PLA), polyethylene oxide-block-polyglycolide (PEO-PLGA), polyethylene oxide-block-polycaprolactone (PEO-PCL), polyethylene-block-polyethylene glycol (PE-PEO), polystyrene-block-polymethylmethacrylate (PS-PMMA), polystyrene-block-polyacrylic acid (PS-PAA), polypyrrole-block-polycaprolactone (PPy-PCL), polysilicone-block-polyetylene oxide (PDMS-PEO), ABA-Block Copolymers (Polyethylenoxid-block-polybutadien-block-polyethylenoxid (PEO-PB-PEO), Polyethylenoxid-block-polypropylenoxid-block-polyethylenoxid (PEO-PPO-PEO), Polypropylenoxid-block-polyethylenoxid-block-polyethylenoxid (PPO-PEO-PPO), Polyethylenoxid-block-polyisobutylen-block-polyethylenoxid (PEO-PIB-PEO), Polyethylenoxid-block-polybutadien-block-polyethylenoxid (PEO-PB-PEO)), Polylactid-block-polyethylenoxid-block-polylactidd (PLA-PEO-PLA), Polyglycolide-block-polyethylene oxide-block-polyglycolide (PGLA-PEO-PGLA), polylactide-co-caprolactone-block-polyethylene oxide-block-polylactide-co-caprolactone (PLCL-PEO-PLCL), polycaprolactone-block-polytetrahydrofuran-block-polycaprolactone (PCL-PTHF-PCL), polypropylene oxide-block-polyethylene oxide-block-polypropylene oxide (PPG-PEO-PPG), polystyrene-block-polybutadiene-block-polystyrene (PS-PB-PS), polystyrene-block-polyethylene-ran-butylene-block-polystyrene (PS-PEB-PS), polystyrene-block-polyisoprene-block-polystyrene (PS-PIPS), ABC block copolymers (polyisoprene-block-polystyrene-block-polyethylene oxide (PI-PS-PEO), polystyrene-block-polyvinylpyrrolidone-block-polyethylene oxide (PS-PVP-PEO), polystyrene-block-poly-2-vinylpyridine-block-polyethylene oxide (PS-P2VP-PEO), polystyrene-block-poly-2-venylpyridine-block-polyethylene oxide (PS-P2VP-PEO), polystyrene-block-polyacrylic acid-polyethylene oxide (PS-PAA-PEO)), polyethylene oxide-block-polylactide-block-decane (PEO-PLA-decane), as well as other amphiphilic polymers (polyethylene oxide alkyl ether (PEO-Cxx), e.g. Brij35, Brij56, Brij58) or mixtures thereof, preferably PEO-PB, PEO-PPO, PEO-PB-PEO, PEO-PPO-PEO, ABCD block copolymers or higher-value block copolymers can be used as a structure-forming template, wherein A, B, C and D represent chemically different polymer segments.

In a further preferred embodiment, the method is characterized in that the metal compound is a colloidal metal particle, preferably a colloidal nanoparticle. Preferably, a metal salt, preferably a metal nitrate, metal halide, metal sulphate, metal acetate, metal citrate, metal alkoxide, or mixtures thereof, can also be used as the metal compound.

In a further preferred embodiment, the method is characterized in that the metal compound is an element and/or a compound and/or a mixture of tin, tungsten, molybdenum, tantalum, niobium, copper, argon, gold, zinc, cadmium, mercury, chromium, manganese, rhenium, iron, ruthenium, osmium, cobalt, rhodium, iridium, nickel, palladium, platinum, preferably platinum, palladium, ruthenium, rhenium, iridium, osmium, particularly preferably platinum, ruthenium, rhenium, and/or iridium.

For the purposes of the present disclosure, the term colloidal in relation to the metal nanoparticles preferably refers to their fine distribution within the second solvent.

For the purposes of the present disclosure, nanoparticles or metal nanoparticles preferably refer to particles which essentially have dimensions of 1 nm to 20 nm. Nanoparticles with dimensions of 1 nm to 10 nm are preferred, particularly preferably 2 nm to 5 nm. Such nanoparticles can be advantageously anchored in the pore walls of the carbon particles produced.

For the purposes of the present disclosure, a metal salt preferably refers to a chemical compound of a metal with a salt. The preferred salts for this purpose are chlorides, acetylacetonates, acetates, nitrates, hexachloroplatinic acid, and also hydrates of these salts. For the purposes of the present disclosure, hydrates preferably refer to compounds containing water.

In some embodiments, the present disclosure also provides for the use of multiple metals or alloys with such metal nanoparticles. Combinations of two or more metals, such as precious metals comprising platinum and rhutenium, are also preferred.

Preferably, the metal of the metal nanoparticles has a melting temperature that is higher than the lowest temperature during the thermal treatment.

It can also be preferred that the metal nanoparticles are surrounded by a protective shell of an ionic stabilizer, which enables the dispersion/dissolution of the metal nanoparticles in a solvent.

In one embodiment of the present disclosure, the ionic stabilizer is quaternary ammonium cation, for example a quaternary alkylammonium cation or quaternary arylammonium cation. An example of such a suitable quaternary ammonium cation is the tetraoctyl ammonium cation, such as in the compound tetraoctylammonium triethyl hydroburate. Preformed stabilized metal nanoparticles according to the present disclosure can be prepared by methods known to those skilled in the art, such as disclosed in U.S. Pat. No. 6,531,304 or U.S. Pat. No. 5,580,492. According to this example, such stabilized metal nanoparticles are obtained by reacting metal salts, halides, pseudohalides, alcoholates, carboxylates or acetylacetonates of metals of groups 6-11 with protolysable organometallic compounds. Alternatively, colloids of transition metals of the periodic table of groups 6-11, which are synthesized by other methods, for example precious metal colloids with corrosion protection of iron, cobalt, nickel or their alloys, can also be synthesized with organometallic compounds. The protective shell of the colloidal starting materials produced in this way contains reactive metal-carbon bonds that can be combined with modifying compounds such as alcohols, carboxylic acids, polymers, polyethers, polyalcohols, polysaccharides, sugars, surfactants, silanols, activated carbons, inorganic oxides or hydroxides. Examples of such modifying compounds are 1-decanol, 2-hydroxypropionic acid, cis-9-octadecenoic acid, triphenylsilanol, glucose, polyethylene glycol, polyvinylpyrolidone and various surfactants such as cationic, anionic, amphiphilic or nonionic surfactants, e.g. Di(hydrotallow)dimethylammonium chloride, lauryldimethylcarboxymethylammonium betaine, Na-cocoamidoethyl-N-hydroxyethyl glycinate, decaethylene glycol hexadecyl ether, polyethylene glycol hexadecyl ether, polyoxyethylene sorbitan monolaurate.

Another way to produce preformed stabilized metal nanoparticles is by reduction of a metal salt selected from tin, copper, silver, gold, zinc, cadmium, mercury, chromium, manganese, rhenium, iron, ruthenium, osmium, cobalt, rhodium, iridium, nickel, palladium and/or platinum and/or combinations thereof with tetraalkylammonium triorganohydroborates, for example tetraoctylammonium, triethylhydroborate, tetrabutylhydroborate, or, more generally, tetra(alkyl) ammonium triethylhydroborate, wherein alkyl=Cl—ClO alkyl, preferably C4-C8 alkyl.

In a further embodiment, the ionic stabilizer is a quaternary alkylammonium cation or a quaternary alkylphosphonium cation, wherein the alkyl has 4-10 carbon atoms in the chain.

In a further preferred embodiment, the method is characterized in that, after method step a), the template-carbon polymer complexes are separated from the first solvent by means of a separation method and the metal compound is combined with the separated template-carbon polymer complexes by means of a second solvent to form a new polymer solution.

In a further preferred embodiment, the method is characterized in that the second solvent used to form the dispersion is an aprotic organic solvent, preferably comprising a cyclic ether, more preferably a tetrahydrofuran (THF) and optionally an alcohol. It is also possible to add ethanol, in particular to avoid polymerization of THF at the temperatures used during carbonization and thus also soot formation. If carbonization is carried out in a subsequent step, the optional use of ethanol is not necessary.

Preferably, the second aprotic solvent has a weak electric dipole moment.

It has been found that the use of pure THF can lead to sooting during the aerosol spraying method. This is due to the fact that THF tends to form various higher molecular weight compounds under the high temperatures during the thermal treatment of the aerosol spray method. A mixture of THF and ethanol is therefore preferred, which advantageously prevents the formation of soot. A particularly suitable mixing ratio of ethanol to THF has essentially proven to be 2:1. It should be noted that pure ethanol is not preferred, as the solution is less pronounced. By using THF as a second solvent, a high degree of purity can be achieved.

In a further preferred embodiment, the method is characterized in that the implementation of an aerosol spraying method according to method step c) comprises the following steps: (i) vaporization of the polymer solution in a vaporizer, (ii) supply of an inert carrier gas to the vaporizer, (iii) transport of the aerosols formed in the vaporizer through the inert carrier gas to a heatable zone for carrying out the thermal treatment.

The concept of vaporization has already been explained at the beginning. For the purposes of the present disclosure, a vaporizer is a device that performs vaporization. The vaporizer is preferably an ultrasonic vaporizer.

For the purposes of the present disclosure, inert gases are preferably gases which are very inert, i.e. which take part in only a few chemical reactions. The addition “carrier” comes from the fact that the metal-containing spherical carbon particles formed during the thermal treatment are transported and/or carried by the inert carrier gas, for example to the thermal treatment.

For the purposes of the present disclosure, aerosols preferably refer to suspended particles from the renewed polymer solution through the second solvent, which are formed during vaporization in and through the vaporizer.

The size of the carbon particles is essentially determined and/or adjusted by the concentration of the renewed polymer solution and/or by parameters such as viscosity, density and surface tension.

The size of the aerosols, which are preferably formed in the vaporizer by oscillation, can be adjusted, for example, by the excitation frequency and the power of the vaporizer. The size and shape of the carbon particles results from the size and shape of the aerosols.

In preferred embodiments, the spherical carbon particles have a diameter (maximum extension) of 50 nm to 5 μm, preferably 100 nm to 2 μm, particularly preferably 200 nm to 1500 nm.

In a further preferred embodiment, the method is characterized in that the vaporizer is an ultrasonic vaporizer.

The aerosols are generated as droplets in the ultrasonic vaporizer preferably by means of mechanical vibrations of up to 3 MHz, which are preferably transmitted to the liquid film. These vibrations are usually generated by piezoceramic elements that convert electrical vibrations into mechanical vibrations. They can lead to the formation of capillary waves on the surface of the liquid film, which rise exponentially with increasing excitation frequency.

If the excitation frequency reaches a certain value, droplets of a certain diameter can form. The droplet diameter decreases with increasing excitation frequency, higher density and/or lower surface tension of the liquid. This can result in droplet sizes of up to 4 μm.

In a further preferred embodiment, the method is characterized in that the inert carrier gas is nitrogen, carbon monoxide, carbon dioxide, methane or mixtures of argon with hydrogen, carbon monoxide or ammonia or a noble gas, preferably helium, neon, argon, krypton or xenon.

The inert carrier gas is preferably essentially free of any oxygen. Possible inert carrier gases comprise nitrogen dioxide, noble gases comprising helium, neon, argon, krypton, xenon, but also carbon monoxide, carbon dioxide, carbon, methane. Mixtures comprising hydrogen and argon, which are preferably easily reducible, are also preferred. Ammonia can preferably also be used. During the thermal treatment in the case of ammonia, so-called ammonolysis takes place, whereby so-called N-functionalities are incorporated into the carbon, which advantageously leads to a better interaction of the carbon with proton-conducting ionomers.

In a preferred embodiment, the method is characterized in that the temperature during the thermal treatment is between 200° C. and 2000° C. A temperature of approx. 400° C. is particularly preferred here, at which particularly stable carbon particles are formed. The thermal treatment converts the polymer into graphitized carbon, the structuring template is decomposed and converts the metal and/or the metal compound into highly active metal nanoparticles.

The thermal treatment is preferably carried out for a period of time in the range from one minute to 240 minutes, preferably from 20 minutes to 180 minutes. The duration can also preferably be in the seconds range. The duration of the thermal treatment depends on a number of parameters, such as the flow of aerosols, which are preferably transferred from the vaporizer to a heating tube for thermal treatment. Preferably, the heating tube can be a quartz tube. The length of the heating pipe can also play a role. The flow should not be so low that the carbon particles settle in the heating pipe itself. Preferably, so much energy, preferably heat, is supplied during the thermal treatment that the second solvent and the template are vaporized and/or decomposed. Preferably, the metal nanoparticles are stably arranged in the spherical carbon spheres. Preferably, the metals, in particular metal ions, are reduced to metal nanoparticles. The melting temperature of the individual metal can also be an important parameter in this synthesis step. In the case of metals with a low melting point (e.g. copper), the high mobility of the atoms in the as yet unsolidified polymer skeleton leads to the formation of comparatively large metal nanoparticles. In contrast, metals that have a comparatively high melting temperature will form relatively small metal nanoparticles.

It can be preferable for the heating tube to have a support plate and thermocouples, with the support plate providing a framework for the heating tube and the thermocouples being responsible for transferring the increased temperature. It can also be preferable that the heating tube for the thermal treatment can be divided into one or more heating zones that have a different temperature. For example, a first heating zone can be used for evaporation of the second solvent and a second heating zone for carbonization, wherein in such a case the second heating zone preferably has a higher temperature than the first heating zone.

In a further preferred embodiment, the method is characterized in that the metal compound comprises a metal salt or colloidal metal nanoparticles and during the thermal treatment the metal salt is reduced to metal nanoparticles.

In a further preferred embodiment, the method is characterized in that the spherical carbon particles are collected by a collector after the thermal treatment.

Preferably, the collector can be a paper filter, absorbent cotton, wool or, in particular, glass wool. The metal-containing spherical carbon particles can also preferably be captured by macroporous materials, which in particular can also serve as carriers, such as ceramics, oxides and/or carbons. In certain embodiments, it can also be preferred that the metal-containing spherical carbon particles are introduced into a wash bottle and subsequently collected in a liquid.

In a further aspect, the present disclosure relates to metal-containing spherical carbon particles producible according to a manufacturing method according to the present disclosure.

The metal-containing spherical carbon particles are preferably characterized in that the pore size is on average smaller than 2 nm or is between 2 nm and 50 nm, preferably 2 nm to 10 nm, particularly preferably 2 nm to 6 nm. A pore range of less than 2 nm is also referred to as micropores or microporous, a range between 2 nm and 50 nm as mesopores or mesoporous and a range greater than 50 nm as macropores or macroporous. The pores are preferably micropores or mesopores.

In a further aspect, the present disclosure relates to a method of producing an ink for a coating method comprising the steps of (i) producing metal-containing spherically porous carbon particles by a method according to one aspect of the present disclosure, (ii) further processing the metal-containing spherically porous carbon particles produced in step (i) into an ink.

The method can be characterized in that an ionomer, a third solvent and optionally other additives are used for the further processing of the metal-containing spherically porous carbon particles into an ink, the preferred ionomers being Nafion, Flemion or other, in particular fluorine-free ionomers, such as sulfonated polyether ketones, aryl ketones and/or polybenzimidazoles.

The method can also be characterized in that a mixture comprising one or more alcohols, preferably ethanol and/or isopropanol, is used as the third solvent. Preferably, water can also be used as an option. This is usually done to prevent an exothermic reaction of the alcohol with air on the catalyst surface. If the ink is produced and sprayed in an inert atmosphere, water can usually be dispensed with.

In a further aspect, the present disclosure relates to an ink producible by means of the method according to the present disclosure. In particular, the metal-containing spherical carbon particles can be further processed into the ink.

Two specific examples of this are given below, one each for the preparation of an ink and for heterogeneous catalysis:

### Example 1: Preparation of an Ink

10 mg of the carbon particles with platinum nanoparticles according to the present disclosure are placed in a beaker, 4 ml of ultrapure water are added and then 1 ml of isopropanol. Finally, 20 μl of 5% Nafion solution is added. The mixture is dispersed for 45-60 minutes with an ultrasonic vaporizer to form a homogeneous ink. The ink is quickly processed into a film. Film synthesis is preferably carried out by drop casting or by spraying onto a suitable substrate. Glassy carbon substrates are preferably used for half-cell tests (one electrode). When testing in a membrane full cell (anode and cathode), the ink is sprayed directly onto the membrane and dried.

### Example 2: Hydrogenation Reaction

4-nitrophenol is added to ultrapure water at a concentration of 1.35 mol/I and preferably the same volume (1 ml) of sodium borohydride is added. 10 μl of a dispersion of the carbon particles according to the present disclosure containing platinum nanoparticles is added in water. Nitrophenol reacts to form aminophenol. The mesoporous carbon particles containing platinum act as a heterogeneous catalyst. The decrease in an absorption band of nitrophenol at a wavelength of approx. 400 nm can be monitored using UV/VIS spectroscopy methods.

In a further aspect, the present disclosure preferably relates to a use of the metal-containing spherical carbon particles according to the present disclosure or an ink according to the present disclosure as a catalyst, preferably in a heterogeneous catalysis and/or electrocatalysis, particularly preferably as a catalyst in water electrolysis, in fuel cells and/or for providing an electrolysis capacitor and/or for providing electrodes, vehicle catalysts, sensors and/or gas containers.

The average person skilled in the art will recognize that technical features, definitions, and advantages of preferred embodiments disclosed for the method of making metal-containing spherical carbon particles according to the present disclosure apply equally to the metal-containing spherical carbon particles made, methods of making an ink comprising metal-containing spherical carbon particles, an ink comprising metal-containing spherical carbon particles, and uses of the metal-containing spherical carbon particles or the ink, and vice versa.

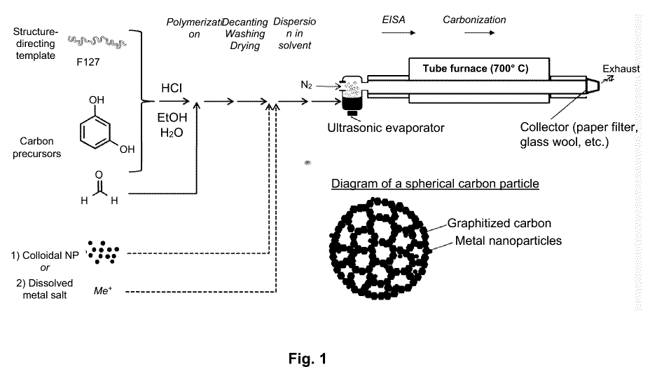

FIG. 1 schematically illustrates the sequence of a preferred method for the production of metal-containing spherically porous carbon particles. In a first step, a structuring template is polymerized with a carbon precursor in a first solvent. In FIG. 1, the structuring template is given by Pluronic F 127 and the carbon precursor by pyrocatechol.

These are added to a solvent comprising hydrogen chloride, water and ethanol and polymerized. This results in the formation of template-carbon polymer complexes. In the next step, the solvent and the template-carbon polymer complexes are separated from each other by decantation. The template-carbon polymer complexes are then placed in a second solvent, into which the metal and/or the metal compound is added. These can be, for example, colloidal metal nanoparticles or a dissolved metal salt, wherein a dispersion occurs. The dispersion is vaporized in an ultrasonic vaporizer. Aerosols form in the ultrasonic vaporizer during vaporization. These are fed from an inert carrier gas, which is supplied to the ultrasonic vaporizer, into a heating tube. The term evaporation-induced self-assembly process (EISA) is preferably used to characterize the autonomous process of formation of the spherical carbon particles. The heating tube is preferably supplied with a high temperature (e.g. 700° C.) so that the thermal treatment (calcination) of the aerosols can take place. The metal-containing, spherically porous carbon particles formed in the process are then collected and deposited by a collector.

Below the diagram illustrating the method according to the present disclosure is a schematic representation of the metal-containing spherical carbon particles according to the present disclosure, which have a graphite structure. They are advantageously electrically conductive and can be used in electrocatalytic reactions. The metal nanoparticles are homogeneously distributed within the spherical, porous carbon particles. An excellent pore arrangement and distribution of the metal nanoparticles in the carbon particles can be achieved with the process according to the present disclosure. This is advantageously transferred to the resulting properties of the metal-containing spherical carbon particles, which are characterized in particular by good electrical conductivity.

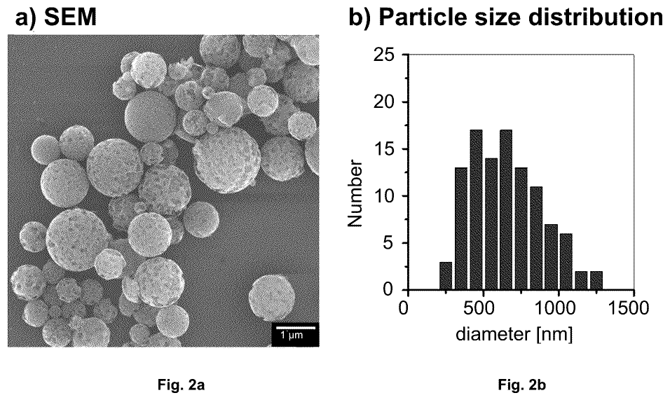

FIG. 2 is a schematic representation of a scanning electron microscope (SEM) image and a size distribution of platinum-containing spherical carbon particles (Pt/C). FIG. 2a clearly shows that the carbon particles have a spherical shape. FIG. 2b shows that most of the platinum-containing carbon particles have a diameter in the range from 200 nm to 1500 nm.

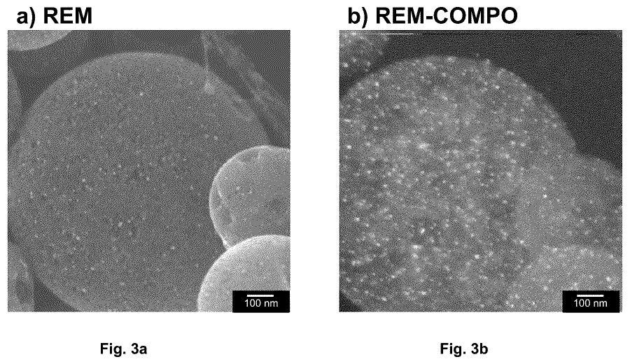

FIG. 3 shows further SEM images of the platinum-containing spherical carbon particles. In FIG. 3a, secondary electrons provide information about the topology of the particles. In FIG. 3b, backscattered electrons allow conclusions to be drawn about the chemical composition. Platinum nanoparticles appear as bright dots in FIG. 3b. The homogeneous distribution of the platinum nanoparticles is clearly visible. The term SEM-COMPO is used to indicate that the SEM image was taken in COMPO mode, i.e. that information regarding the composition was also obtained.

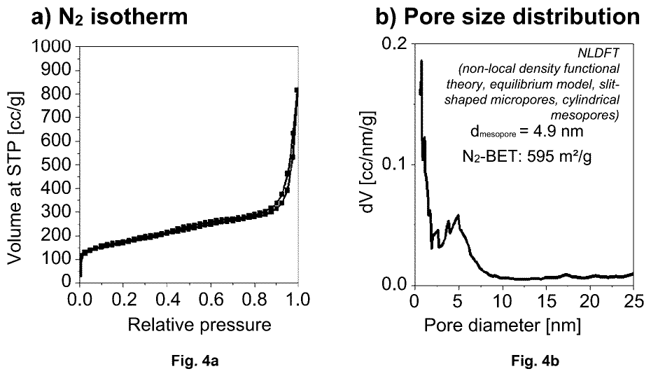

FIG. 4 shows further measurement results for the carbon particles. FIG. 4a shows an isotherm of nitrogen dioxide at a temperature of 77 K. FIG. 4b shows a pore size distribution from a discrete Fourier transform (DFT) from FIG. 4a. The average diameter of the pores is approx. 5 nm.

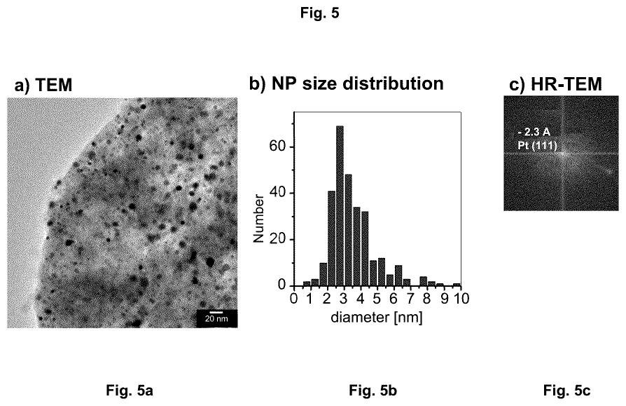

FIG. 5a shows a transmission electron micrograph (TEM image) of a carbon particle containing platinum. Dark areas can be assigned to platinum nanoparticles. FIG. 5b shows a size distribution of the particle diameters from the TEM images. The abbreviation NP stands for nanoparticles. The platinum nanoparticles have a diameter of 1 nm to 10 nm, in particular 2 nm to 5 nm. FIG. 5c shows a high resolution transmission electron microscopy (HR-TEM) image at high magnification with the use of a fast Fourier transform (FFT).

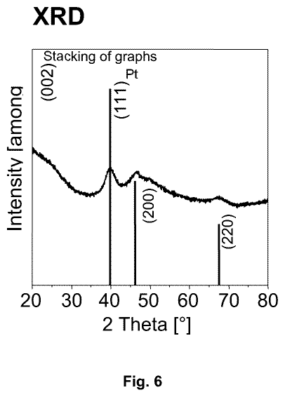

FIG. 6 shows an X-ray diffractogram. The observed reflexes can be assigned to the platinum nanoparticles.

1.-15. (canceled)

16. A method for producing metal-containing spherically porous carbon particles comprising the following steps:
(a) polymerization of a carbon precursor with a structure-forming template by addition to a first solvent to form a polymer solution containing template-carbon polymer complexes;
(b) addition of a metal compound to the polymer solution from the previous step; and
(c) vaporization and thermal treatment of the polymer solution containing the metal compound from the previous step in an aerosol spraying method to form metal-containing spherical carbon particles, wherein during the thermal treatment the template is decomposed and pores are formed within the carbon particles.

17. The method of claim 16, wherein the carbon precursor comprises at least one phenolic compound and optionally at least one crosslinkable aldehyde compound.

18. The method of claim 16, wherein the first solvent from method step (a) is a protic solvent, preferably a mixture of an alcohol such as methanol or ethanol, water and optionally an acid or base.

19. The method of claim 16, wherein after method step (a), the template-carbon polymer complexes are separated from the first solvent using a separation method.

20. The method of claim 16, wherein the structure-forming template is a template for the formation of micelle or lamellar structures and an amphiphilic molecule, preferably a surfactant, particularly preferably a surfactant comprising nonionic, cationic, anionic and/or zwitterionic surfactants and/or mixtures thereof.

21. The method of claim 16, wherein the structure-forming template is an amphiphilic polymer, preferably an amphiphilic block copolymer, particularly preferably a poloxamer.

22. The method of claim 16, wherein the metal compound is a colloidal metal particle, preferably a colloidal nanoparticle or a metal salt, preferably a metal nitrate, metal halide, metal sulphate, metal acetate, metal citrate, metal alkoxide or mixtures thereof.

23. The method of claim 16, wherein after method step (a), the template-carbon polymer complexes are separated from the first solvent by means of a separation method and the metal compound is combined with the separated template-carbon polymer complexes by means of a second solvent to form a new polymer solution, wherein the second solvent used to form the dispersion comprises an aprotic organic solvent, preferably a cyclic ether, more preferably a tetrahydrofuran (THF) and optionally an alcohol.

24. The method of claim 16, wherein the implementation of an aerosol spraying method according to method step c) comprises the following steps:
(i) vaporization of the polymer solution in a vaporizer
(ii) supply of an inert carrier gas to the vaporizer
(iii) transport of the aerosols formed in the vaporizer through the inert carrier gas to a heatable zone for carrying out the thermal treatment.

25. The method of claim 24, wherein the vaporizer is an ultrasonic vaporizer.

26. The method of claim 24, wherein the temperature during thermal treatment is between 200° C. and 2000° C. and/or the metal compound comprises a metal salt or colloidal metal nanoparticles and during the thermal treatment the metal salt is reduced to metal nanoparticles.

27. Metal-containing spherical carbon particles produced by a manufacturing method, comprising:
(a) polymerization of a carbon precursor with a structure-forming template by addition to a first solvent to form a polymer solution containing template-carbon polymer complexes;
(b) addition of a metal compound to the polymer solution from the previous step; and
(c) vaporization and thermal treatment of the polymer solution containing the metal compound from the previous step in an aerosol spraying method to form metal-containing spherical carbon particles, wherein during the thermal treatment the template is decomposed and pores are formed within the carbon particles.

28. A method of preparing and using an ink for a coating, comprising steps of production of metal-containing spherically porous carbon particles by:
(a) polymerization of a carbon precursor with a structure-forming template by addition to a first solvent to form a polymer solution containing template-carbon polymer complexes;
(b) addition of a metal compound to the polymer solution from the previous step; and
(c) vaporization and thermal treatment of the polymer solution containing the metal compound from the previous step in an aerosol spraying method to form metal-containing spherical carbon particles, wherein during the thermal treatment the template is decomposed and pores are formed within the carbon particles; and
processing the metal-containing spherically porous carbon particles produced in steps (a), (b), and (c) into the ink.

29. The method of claim 28, further comprising using the metal-containing spherical carbon particles or the ink as a catalyst, in heterogeneous catalysis and/or electrocatalysis, as a catalyst in water electrolysis, in fuel cells and/or for providing an electrolysis capacitor and/or for providing electrodes, vehicle catalysts, sensors, and/or gas containers.
